(19) United States
(12) Patent Application Publication
(10) Pub. No.: US 2008/0298744 A1
(43) Pub. Date: Dec. 4, 2008

(54) PHOTONIC CRYSTAL STRUCTURE AND METHOD OF MANUFACTURING THE SAME

(75) Inventors: Shinan Wang, Kashiwa-shi (JP); Kenji Tamamori, Ebina-shi (JP); Taiko Motoi, Atsugi-shi (JP); Masahiko Okunuki, Akiruno-shi (JP); Haruhito Ono, Minamiashigara-shi (JP); Toshiaki Aiba, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/127,154

(22) Filed: May 27, 2008

(30) Foreign Application Priority Data
May 31, 2007 (JP) 2007-144443

(51) Int. Cl. G02B 6/26

(52) U.S. Cl. 385/27

(57) ABSTRACT

A photonic crystal structure is provided the optical characteristics of which vary periodically in at least one direction, wherein the base material of the photonic crystal structure is formed of a dielectric material, a region containing at least one of molecules, atoms and ions different from the constituent element of the base material is provided in the base material, and the region is arranged in the base material so that the density of one of the molecules, atoms and ions varies periodically in the one direction.

### BACKGROUND OF THE INVENTION

1. Field of the Invention

The present invention relates to a photonic crystal structure and a method of manufacturing the photonic crystal structure.

2. Related Background Art

A photonic crystal is a structure in which the refractive indexes of constituent substances are distributed periodically. The photonic crystal is an artificial material capable of realizing novel functions simply by means of structural design. The most noteworthy feature of the photonic crystal is that there is formed therein a so-called photonic band gap, a region through which a specific electromagnetic wave cannot propagate because of the refractive index difference and structural periodicity of constituent materials. When a defect is introduced into the refractive index distribution of the photonic crystal, an energy level (defect level) due to this defect is formed in the photonic band gap. Consequently, the photonic crystal can freely control electromagnetic waves. In addition, the size of a device making use of the photonic crystal can be made by far smaller than that of a conventional device. A three-dimensional photonic crystal, among photonic crystals, has the feature that the refractive index distribution of constituent substances has a three-dimensional period and an electromagnetic wave present at a defect position can hardly leak out. This means that the three-dimensional photonic crystal is best suited for the control of electromagnetic wave propagation.

As one of typical structures in such a three-dimensional photonic crystal as described above, there is known a woodpile structure (or rod-pile structure) disclosed in U.S. Pat. No. 5,335,240. This woodpile structure of the three-dimensional photonic crystal is such as illustrated in FIG. 5. In FIG. 5, a three-dimensional periodic structure 500 includes a plurality of stripe layers in which a plurality of rods 501 is periodically disposed in parallel with each other and at a predetermined in-plane period and which is successively laminated.

Specifically, the three-dimensional periodic structure includes: a first stripe layer in which a plurality of rods is periodically disposed in parallel with each other and at a predetermined in-plane period; a second stripe layer laminated on the first stripe layer so as to be orthogonal to respective rods belonging to the first stripe layer; a third stripe layer laminated on the second stripe layer so as to be parallel with respective rods belonging to the first stripe layer and out of alignment with the rods by half of the in-plane period; and a fourth stripe layer laminated on the third stripe layer so as to be parallel with respective rods belonging to the second stripe layer and out of alignment with the rods by half of the in-plane period; wherein the first to forth stripe layers are grouped as a set and a plurality of sets is successively laminated.

The period of the photonic crystal structure in this case is approximately half the wavelength of an electromagnetic wave to be controlled. In the case of a photonic crystal device for visible light, for example, the in-plane period of rods is approximately 250 nm.

In addition, U.S. Pat. No. 6,993,235 proposes a joint rod type three-dimensional photonic crystal since the photonic crystal exhibits a perfect photonic band gap in a wider wavelength region. This joint rod type three-dimensional photonic crystal has such a structure as illustrated in FIGS. 6A and 6B. In FIGS. 6A and 6B, a three-dimensional periodic structure 600 is such that a joint part 620 larger than the regional area of an intersection point between rod parts 601 corresponding to rods of a woodpile structure is disposed at the intersection point.

Whereas ideal device characteristics are expected from the three-dimensional photonic crystal having such a microscopic three-dimensional structure as described above, the photonic crystal is generally complex in structure and requires many cumbersome steps for manufacturing. In addition, the structural period of the photonic crystal becomes shorter with a decrease in the wavelength of an electromagnetic wave to be controlled. Hence, the required critical dimensions (CD) of structure also reduce. As a result, requirements for interlayer alignment accuracy and structural processing accuracy become increasingly stringent.

Conventionally, Japanese Patent Application Laid-Open No. 2004-219688 proposes a method of thermally adhering heterogeneous members based on such a layering technique as described below, as a method of manufacturing a three-dimensional photonic crystal having a woodpile structure. In the thermal adhesion method discussed here, there is first formed a rod array disposed in parallel with stripe layers provided on a substrate and at a predetermined in-plane period. Then, after joining the stripe layers to each other using a thermal adhesion method while making an interlayer alignment, the substrate of one stripe layer is removed. By repeating such steps as described above, there is obtained a woodpile structure having as many layers as the frequency of junction. Thus, it is considered possible to manufacture a three-dimensional photonic crystal having a relatively complex structure using such a layering technique as described above.

On the other hand, U.S. Pat. No. 5,236,547 discloses such a method of forming a pattern and a method of manufacturing a semiconductor device as described below, among conventional thin-film processing methods. Here, thin-film processing is made possible by such a step of ion beam implantation and a step of performing dry etching on a material to be etched as described below. That is, ions are implanted in the ion beam implantation step, while changing the implantation position of an ion beam to be focused on the material being etched and varying at least one of the acceleration voltage of the ion beam, the atomic species of ions, and the valence of ions. Thus, an ion concentration peak region is formed in the depth direction of the material being etched. In addition, in a step of performing dry etching, the material being etched is dry-etched using an etching gas for forming ions and an etching-inhibiting region in the ion concentration peak region of the material being etched. By following these steps, thin-film processing is carried out.

Incidentally, a certain periodic number is required not only in an in-plane direction but also in a thickness direction, in order to obtain desired device characteristics in a three-dimensional photonic crystal. In general, a periodic number in a thickness direction is desired to be 3 or larger. As far as the above-described woodpile structure is concerned, lamination of 12 or more stripe layers is required. In addition, a reduction in the processing error of each structure and an interlayer alignment error is required in order to obtain desired device characteristics. For example, the processing error of each rod is desirably less than approximately 10% of the rod period in the case of a three-dimensional photonic crystal having a woodpile structure. In addition, the interlayer alignment error is desirably less than approximately 25% of the rod period. In the case of a photonic crystal device for visible light, the in-plane period of rods is approximately 250 nm. This means that the processing error of each rod is less than approximately ±25 nm and each interlayer alignment error is less than approximately ±60 nm.

However, such a conventional laminating method as described in patent document 3 poses the problem, when manufacturing the three-dimensional photonic crystal, that a manufacture method is complex, the number of steps increases in proportion to the number of layers of the photonic crystal and, therefore, the degree of technical difficulty increases, though existing semiconductor technologies can be applied. Consequently, with such a method as described above, it is extremely difficult to improve productivity. Another problem is that the accumulation of alignment errors is unavoidable since alignment is necessary at each time of lamination. In addition, not only the discontinuity of material (i.e., refractive index) occurs in each interlaminar interface but also dust adhesion or contamination unavoidable in a manufacturing process occurs, thereby causing unwanted electromagnetic wave scattering. Furthermore, a structural deformation also occurs since stress inside a structure increases with an increase in the number of layers. These structural disorders adversely affect the characteristics of the photonic crystal device. From these considerations, it is difficult to precisely manufacture the three-dimensional photonic crystal with the above-described conventional laminating method.

On the other hand, in the conventional thin-film processing method described in U.S. Pat. No. 5,236,547, it is considered possible to process the material under etching in the depth direction thereof. However, no solutions have been proposed yet to the problem of enabling the manufacture of a three-dimensional photonic crystal having such a complex structure as a woodpile structure using these techniques.

In light of the aforementioned problems, it is an object of the present invention to provide a method of manufacturing a photonic crystal structure whereby it is possible to provide a photonic crystal structure capable of improving device characteristics and manufacture a complex three-dimensional structure, a nanophotonic crystal in particular, with precision and simplicity and at low costs.

### SUMMARY OF THE INVENTION

In order to solve the aforementioned problems, the present invention is directed to providing a photonic crystal structure configured as described below and a method of manufacturing the photonic crystal structure.

The present invention is directed to a photonic crystal structure the optical characteristics of which vary periodically in at least one direction, wherein the base material of the photonic crystal structure is formed of a dielectric material, a region containing at least one of molecules, atoms and ions different from the constituent element of the base material is provided in the base material, and the region is arranged in the base material so that the density of one of the molecules, atoms and ions varies periodically in the one direction.

The base material of the photonic crystal structure can be one of a continuous body and a multilayer film.

The dielectric material can be one of Si and a compound containing Si.

The dielectric material constituting the base material can be formed of two types of dielectric materials and the region is formed in a base material made of at least one of the two dielectric materials. In the photonic crystal structure, one type of the dielectric materials can be one of vacuum and a gas containing air and the other type of the dielectric materials is one of Si and a compound containing Si. The base material of the photonic crystal structure can be a multilayer film.

In the photonic crystal structure, at least one of the molecules, atoms and ions can be a metal selected from the group consisting of Ga and In or a nonmetal selected from the group consisting of B, P, Si, Ar, oxygen and nitrogen.

The period at which the optical characteristics vary periodically can be several tens of nanometers to several tens of micrometers.

In the period at which the density of one of the molecules, atoms and ions varies periodically can be several tens of nanometers to several tens of micrometers.

The present invention is directed to a method of manufacturing a photonic crystal structure the optical characteristics of which vary periodically in at least one direction, the method comprising: preparing the base material of the photonic crystal structure; and; implanting ions by scanning a focused ion beam on the base material while varying the acceleration voltage of the focused ion beam, in order to form an ion-implanted region in the base material, so that the density of the ions varies periodically in the one direction as the result of the region being formed.

In the method of manufacturing a photonic crystal structure, a thin film can be formed as the base material in the preparation of the base material of the photonic crystal structure.

The thin film can be formed using one of sputtering, vacuum deposition, chemical vapor deposition and epitaxial growth.

The method of manufacturing a photonic crystal structure, can further include selectively removing the region in which ions have been implanted or parts not containing the ions other than the region in which ions have been implanted, following the ion implantation. The selective removal of the region in which ions have been implanted or parts not containing the ions other than the region in which ions have been implanted can be performed by one of plasma etching, gas etching and solution etching.

The method of manufacturing a photonic crystal structure can further include reformulating, by heat treatment, the region in which ions have been implanted in the base material, following the ion implantation.

According to the present invention, it is possible to provide a photonic crystal structure capable of improving device characteristics. It is also possible to realize a method of manufacturing a photonic crystal structure whereby a complex three-dimensional structure, a nanophotonic crystal in particular, can be manufactured with precision and simplicity and at low costs.

Further features of the present invention will become apparent from the following description of exemplary embodiments with reference to the attached drawings.

### BRIEF DESCRIPTION OF THE DRAWINGS

FIGS. 1A, 1B, 1C, 1D and 1E are schematic views illustrating a manufacturing process used to describe a method of manufacturing a photonic crystal in an exemplary embodiment and Example 1 of the present invention.

FIG. 2 is a schematic view used to describe a constitutional example of a photonic crystal structure in exemplary embodiments and Example 2 of the present invention.

FIG. 3 is a schematic view used to describe a constitutional example of a photonic crystal structure in Example 3 of the present invention.

FIG. 4 is a schematic view used to describe the manufacture of a photonic crystal structure in Example 4 of the present invention.

FIG. 5 is a pattern diagram used to describe a three-dimensional photonic crystal having a conventional woodpile structure.

FIGS. 6A and 6B are pattern diagrams used to describe a conventional joint rod type three-dimensional photonic crystal structure.

### DETAILED DESCRIPTION OF THE EMBODIMENTS

Now, exemplary embodiments of the present invention will be described.

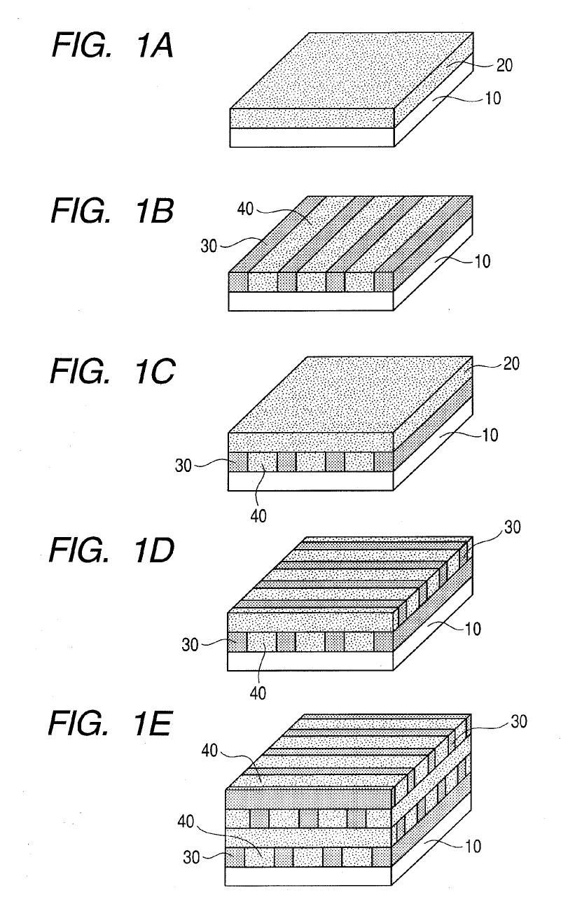

FIGS. 1A to 1E are schematic views illustrating a manufacturing process used to describe a method of manufacturing a photonic crystal in an exemplary embodiment of the present invention. Note that like numerals are used to denote like elements in the figures. Here, a constitutional example of a three-dimensional nanophotonic crystal structure in the present exemplary embodiment illustrated in FIG. 1E will be first described, prior to describing a method of manufacturing a photonic crystal of the present exemplary embodiment.

In FIG. 1E, reference numeral 10 denotes a substrate and reference numeral 30 denotes a part of a photonic crystal base material 20 formed of a dielectric material (hereinafter, this part is referred to as the base material part 30) illustrated in FIG. 1A. The base material part 30 is configured by arranging at least one of molecules, atoms and ions different from the constituent element of the base material 20 of the photonic crystal structure. In contrast, reference numeral 40 denotes a part of a photonic crystal base material (hereinafter this part is referred to as the base material part 40) which is the same in constituent material as the base material 20 of the photonic crystal structure. None of the aforementioned molecules, atoms and ions is arranged in this base material part 40.

In the presence of one of the molecules, atoms and ions, the refractive index of the base material part 30 differs from that of the base material part 40. In general, this difference in refractive index becomes larger in proportion to the density of one of the molecules, atoms and ions. That is, a base material formed of a dielectric material is used and a region containing at least one of molecules, atoms and ions different from the constituent element of the base material is formed in the base material. At this time, the region is arranged in the base material so that the density of one of the molecules, atoms and ions varies periodically in the aforementioned one direction. By obtaining such a structure as described above, it is possible to configure the photonic crystal. That is, the density distribution of one of the molecules, atoms and ions is periodically varied to change the refractive index difference, thereby enabling obtainment of a photonic crystal structure the optical characteristics of which vary periodically in at least one direction. At that time, it is possible to adopt a configuration in which the period at which the optical characteristics vary periodically or the period at which the density of one of the molecules, atoms and ions varies periodically is several tens of nanometers to several tens of micrometers.

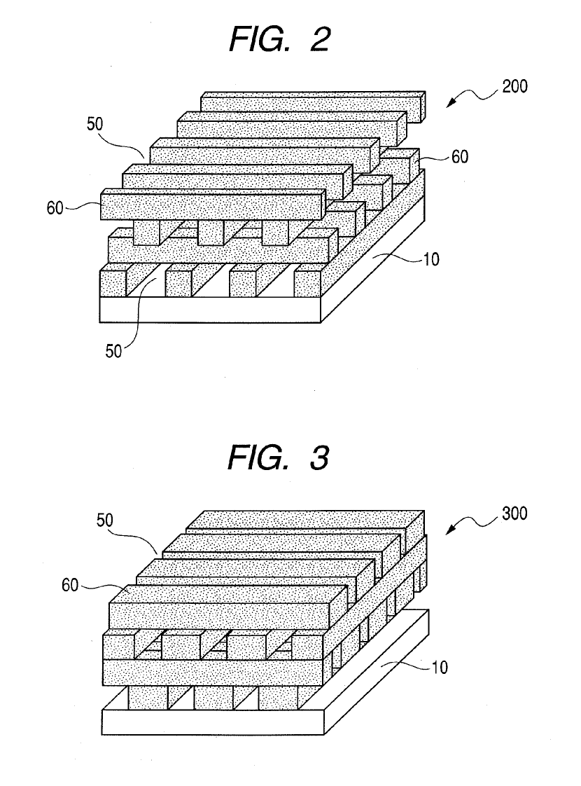

Here, FIG. 2 illustrates another constitutional example of a three-dimensional periodic structure, a three-dimensional nanophotonic crystal in particular, different from the constitutional example of FIG. 1E in the present exemplary embodiment. In FIG. 2, reference numeral 10 denotes a substrate, reference numeral 50 denotes an ambient atmosphere part, and reference numeral 60 denotes rods of the photonic crystal. The ambient atmosphere part 50 can be formed of vacuum, a gas containing air, or the like. This photonic crystal is equivalent to the photonic crystal illustrated in FIG. 1E from which the base material part 40 is removed. That is, the rods 60 correspond to the base material part 30 in FIGS. 1A to 1E and at least one of molecules atoms and ions different from the constituent element of the base material is arranged in the photonic crystal base material. The refractive index difference of such a photonic crystal as described above corresponds to a refractive index difference between the rods 60 and the ambient atmosphere part 50 and, therefore, is larger than that of the photonic crystal illustrated in FIG. 1E. In addition, a larger refractive index difference is available from the photonic crystal illustrated in FIG. 2, when compared with a conventional photonic crystal simply formed of a base material. Accordingly, better photonic crystal characteristics can be obtained. By configuring the base material in this way using two types of dielectric materials, i.e., the ambient atmosphere part 50 and another dielectric material, it is possible to obtain such excellent characteristics as described above. That is, one of vacuum and a gas containing air composing the ambient atmosphere part 50 is applied as one type of the dielectric materials and one of Si and a compound containing Si is applied as the other type of the dielectric materials. In addition, the region is arranged in the base material formed of another type of material other than these types so that the density of one of the molecules, atoms and ions varies periodically in the aforementioned one direction. By configuring the base material in this way, it is possible to obtain such excellent characteristics as described above.

When composing the dielectric material of the base material part 30 in the photonic crystal, it is possible to use Si, a compound containing Si, or the like, as the dielectric material. Alternatively, it is possible to use a semiconductor such as GaN, GaAs, InP or InGaAs, or an oxide such as TiO₂, SiO₂ or ZnO. A transparent member, such as glass or acrylic, can also be used. Base materials formed of these dielectric materials, can be configured using one of a continuous body and a multilayer film. In addition, it is possible to use a metal such as Ga or In, or a nonmetal such as B, P, Si, Ar, oxygen or nitrogen, as one of the molecules, atoms and ions in the photonic crystal. In the photonic crystal described above, the period is desirably several tens of nanometers to several tens of micrometers or several hundred nanometers to several micrometers.

Next, using FIGS. 1A to 1E, a description will be made of a method of manufacturing a photonic crystal structure in the present exemplary embodiment in which optical characteristics vary periodically in at least one direction. First, the photonic crystal base material 20 is formed on the substrate 10 in a step of preparing a photonic crystal base material, as illustrated in FIG. 1A. Hereinafter, this step is also referred to as the film-forming step. The photonic crystal base material 20 is fabricated on the substrate 10 using such a method as sputtering, deposition or junction. A single crystal or an amorphous dielectric material is suitable as the base material 20 for the present invention. Specifically, examples of the base material 20 include Si, GaN, GaAs, InP, InGaAs, TiO₂, SiO₂ and ZnO. The size of the base material 20 is desirably approximately 1 to 1000 μm in length and width, respectively, and several tens of nanometers to several tens of micrometers in thickness. The film-forming surface of the substrate 10 is flat and adherent to the base material 20 to be formed. For example, the substrate 10 is made of an elementary substance of quartz, sapphire, glass, acrylic, Si, GaN, GaAs, InP, InGaAs, TiO₂ or ZnO, or of another material having a thin film of any of these substances. An adhesion layer for improving adhesiveness may be formed, as necessary, on a surface of the substrate 10 in contact with the photonic crystal base material 20. After the film-forming step, alignment marks (not illustrated) are formed on the base material 20. These alignment marks may be formed on the substrate 10 prior to film-forming. As a method of forming the alignment marks, it is possible to use, for example, photolithography and a lift-off method. For the material of the alignment marks, Cr, Au or the like can be used.

Next, a focused ion beam is scanned on the photonic crystal base material while varying the acceleration voltage of the focused ion beam, in order to form an ion-implanted region in the base material. A base material part (first layer) is formed in a step of implanting ions, so that the density of the ions varies periodically in the aforementioned one direction as the result of the region being formed. That is, as illustrated in FIG. 1B, there is formed a base material part 30 (first layer) in which at least one of molecules, atoms and ions different from the constituent element of the base material 20 is arranged (implanted) in the base material 20. Hereinafter, this step is also referred to as an ion arrangement step and, therefore, a focused ion beam (hereinafter also referred to as an FIB) can be used. The distribution of one of the molecules, atoms and ions in the depth direction thereof is controlled by the acceleration voltage of an FIB, the in-plane distribution thereof (i.e., pattern shape) is controlled by the in-plane scanning of the FIB, and the density thereof is controlled by the current and implantation time of the FIB.

Once the type of the base material 20 and the type of one of the molecules, atoms and ions are determined, it is possible to evaluate the acceleration voltage and the implantation time necessary to obtain predetermined depths and densities by simple simulation. Consequently, it is possible to form the base material part 30 with simplicity and high precision. For one of the molecules, atoms and ions, a metal such as Ga or In or a nonmetal such as B, P, Si, Ar, oxygen or nitrogen can be used. The focused ion beam can be either a single beam or multiple beams, as necessary. In the case of multiple beams, it is possible to further improve the efficiency of the ion arrangement step by setting the acceleration voltage, current, diameter and scan of each beam independently of other beams. In this ion arrangement step, the in-plane positioning of the base material part 30 is based on the alignment marks formed on the base material 20.

Next, as shown in FIG. 1C, a film-forming step is performed using the sample obtained in the ion arrangement step illustrated in FIG. 1B as a substrate, to newly fabricate the base material 20. At this time, the method illustrated in FIG. 1A, for example, is available as a method of forming the base material 20. In this film-forming step, the alignment marks are protected.

Next, as illustrated in FIG. 1D, the ion arrangement step illustrated in FIG. 1B is performed on the base material 20 newly formed in FIG. 1C, in order to arrange one of the molecules, atoms and ions in the base material 20 (second layer). In the above-described example, the pattern of the base material part 30 in the second layer is orthogonal to that of the first layer since a woodpile structure is formed. Also in this ion arrangement step, the in-plane positioning (i.e., pattern positioning) of the base material part 30 is based on the alignment marks.

Next, as illustrated in FIG. 1E, the film-forming step illustrated in FIG. 1C and the ion arrangement step illustrated in FIG. 1D are repeated a predetermined number of times, in order to complete a woodpile structure having a predetermined period (FIG. 1E). Here, there is illustrated a four-layer photonic crystal structure, i.e., a photonic crystal structure having one period.

In the description heretofore made, the film-forming step and the ion arrangement step are respectively performed once when forming a base material part 30 within one layer, i.e., rods 60 of the photonic crystal. If the thickness of rods 60 is large (for example, 200 nm or thicker), the film-forming step and the ion arrangement step may be repeated several times, in order to form one layer of rods. By so doing, it is possible to uniformly perform the ion arrangement step in the thickness direction of rods even if a relatively low acceleration voltage is used. In contrast, if the thickness of rods is small (for example, 50 nm or thinner), several layers of rods may be formed by one-time execution of the film-forming step and ion arrangement step. By so doing, it is possible to reduce the number of fabrication steps. The three-dimensional structure formed in the above-described steps can meet a processing accuracy requirement of approximately several nanometers, thus having an accuracy level one or more orders of magnitude higher than that of a conventional three-dimensional structure.

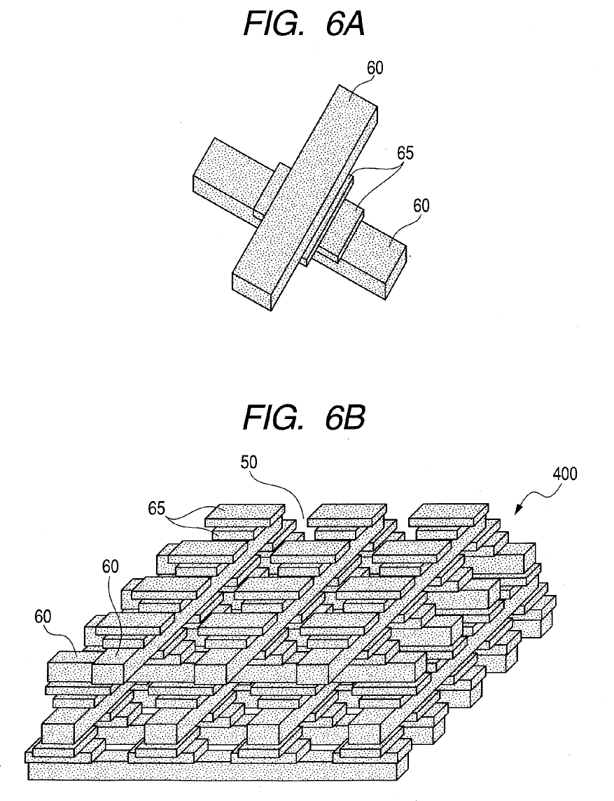

In the foregoing case, only a three-dimensional woodpile structure has been shown for purposes of description. However, the above-described method can be applied to other three-dimensional structures. For example, it is possible to simply form a photonic crystal using a method of manufacturing a photonic crystal according to the present exemplary embodiment, also in the case of the joint rod type photonic crystal structure illustrated in FIGS. 6A and 6B. Furthermore, it is possible to more simply form various types of two-dimensional or one-dimensional photonic crystals using the method of manufacturing a photonic crystal according to the present exemplary embodiment.

### EXEMPLARY EMBODIMENTS

Hereinafter, exemplary embodiments of the present invention will be described. It should be noted that the present invention is not limited by these exemplary embodiments.

### Exemplary Embodiment 1

In exemplary embodiment 1, a description will be made of a method of manufacturing a three-dimensional photonic crystal in which a woodpile structure having a predetermined period is formed by repeating a film-forming step and an ion arrangement step a predetermined number of times. Since the method of manufacturing the three-dimensional photonic crystal in the present exemplary embodiment follows basically the same steps as the method of manufacturing the photonic crystal described in an exemplary embodiment of the present invention, FIGS. 1A to 1E are also used here to describe the present exemplary embodiment.

In FIGS. 1A to 1E, reference numeral 10 denotes a quartz substrate, and reference numeral 20 denotes the base material of a photonic crystal structure formed of an amorphous Si thin film (hereinafter referred to as the Si thin film).

First, a thin film is formed in a step of preparing a photonic crystal base material, as described below, as the base material of the photonic crystal structure. That is, as illustrated in FIG. 1A, an approximately 100 nm-thick Si thin film is formed on the quartz substrate 10 using a sputtering method. Hereinafter, this step is also referred to as a film-forming step. Note that although sputtering is used here to form the thin film, one of vacuum deposition, chemical vapor deposition and epitaxial growth may be used instead of sputtering. After the film-forming step, alignment marks made of Cr or Au are formed (not illustrated) on the Si thin film 20 using photolithography and a lift-off method. These alignment marks may be formed on the Si substrate 10 prior to film-forming.

Next, as illustrated in FIG. 1B, Ga ions are arranged (implanted) in the base material part 30 of the Si thin film 20 using a focused ion beam (hereinafter also referred to as an FIB), in order to form a first layer of a pattern. Pattern formation is controlled by in-plane scanning. The Ga ion distribution in the depth direction of the Si thin film is controlled by the acceleration voltage of the FIB. For example, ion arrangement is performed while varying the FIB acceleration voltage in several steps between 0.5 kV and 120 kV, in order to uniformly arrange Ga ions in the depth direction of the Si thin film. The density of Ga ions is controlled by the current, diameter and irradiation time of the FIB. The value of the density is set to, for example, 1×10²⁰ cm⁻³ as a practical value between 1×10¹⁸ to 1×10²³ cm⁻³. Since the thickness of the Si thin film 20 is known, it is possible to easily optimize ion implantation conditions including the acceleration voltage, current and irradiation time by performing simple simulation on the target Ga ion density. In this ion arrangement step, the in-plane positioning of the base material part 30 (i.e., pattern positioning) is based on the alignment marks formed on the Si thin film 20.

Next, as illustrated in FIG. 1C, an approximately 100 nm-thick amorphous Si thin film 20 is newly formed using a sputtering method, with the sample obtained in the ion arrangement step of FIG. 1B as the substrate. In this film-forming step, the alignment marks are covered with a metal plate and thereby protected.

Next, as illustrated in FIG. 1D, the Ga ion arrangement step illustrated in FIG. 1B is performed on the Si thin film 20 newly formed in FIG. 1C, in order to form a second layer of a Ga ion pattern in the Si thin film 20. In this case, the pattern of the base material part 30 of the second layer is orthogonal to that of the first layer since a woodpile structure is formed. Also in this Ga ion arrangement step, the in-plane positioning (i.e., pattern positioning) of the base material part 30 is based on the alignment marks.

Next, as illustrated in FIG. 1E, the step of forming the Si thin film 20 illustrated in FIG. 1C and the step of arranging Ga ions illustrated in FIG. 1D are repeated a predetermined number of times, in order to complete a woodpile structure having a predetermined period (FIG. 1E). Here, there is illustrated a four-layer photonic crystal structure, i.e., a photonic crystal structure having one period. The three-dimensional structure formed in the above-described steps can meet a processing accuracy requirement of approximately several nanometers, thus having an accuracy level one or more orders of magnitude higher than that of a conventional three-dimensional structure.

### Exemplary Embodiment 2

In exemplary embodiment 2, a description will be made of a constitutional example of a photonic crystal structure to be newly fabricated using the photonic crystal formed in exemplary embodiment 1. Since the present exemplary embodiment is based on a structure basically the same as the photonic crystal structure illustrated in FIG. 2 in the above-described exemplary embodiment of the present invention, FIG. 2 is also used here to describe the present exemplary embodiment. As described with reference to the photonic crystal structure illustrated in FIG. 2 in the above-described exemplary embodiment of the present invention, this photonic crystal is equivalent to the photonic crystal illustrated in FIG. 1E from which the base material part 40 is removed. That is, the rods 60 correspond to the base material part 30 in FIGS. 1A to 1E, and at least one of molecules, atoms and ions different from the constituent element of the base material is arranged in the photonic crystal base material. The refractive index difference of such a photonic crystal equals the refractive index difference between the rods 60 and the ambient atmosphere part 50 and, therefore, is larger than the refractive index difference of the photonic crystal illustrated in FIG. 1E. In addition, a larger refractive index difference is available from the photonic crystal illustrated in FIG. 2, when compared with a conventional photonic crystal simply formed of a base material. Accordingly, better photonic crystal characteristics can be obtained.

The method of manufacturing the photonic crystal is simple. That is, the method uses a step which further includes a step of selectively removing parts not containing the ions other than the region in which the ions have been implanted, following the above-described step of implanting ions. For example, the photonic crystal structure formed in exemplary embodiment 1 is placed in an XeF₂ gas atmosphere. At this time, Si reacts chemically with XeF₂ in the base material part 40 in FIG. 1E, i.e., in a part of Si not containing Ga ions, to form a highly-volatile Si fluoride and evaporate.

On the other hand, Ga reacts chemically with XeF₂ on a surface of the base material part 30 containing Ga ions, to form an extremely involatile Ga fluoride. This Ga fluoride forms a protective film on a surface of the base material part 30, thus functioning in such a manner that Si in the base material part 30 does not react chemically with XeF₂. As a result, the base material part 40 is completely removed and there is formed a woodpile-structure photonic crystal formed of the rods 60 and the ambient atmosphere part 50.

Ideally, the above-described process is performed inside a container capable of introducing and exhausting gases. In that case, the container is first evacuated into a depressurized state. Then, an XeF₂ gas is introduced to a certain pressure level to selectively remove Si. Then, the container is evacuated as appropriate in order to remove gases, including reaction products. By repeating these XeF₂ gas introduction and evacuation steps, it is possible to efficiently fabricate the photonic crystal.

### Exemplary Embodiment 3

In exemplary embodiment 3, a description will be made of a constitutional example of a photonic crystal structure which is newly fabricated using the photonic crystal formed in exemplary embodiment 1 and is different from the photonic crystal structure of exemplary embodiment 2. FIG. 3 illustrates a schematic view used to describe the photonic crystal structure of the present exemplary embodiment. In the present exemplary embodiment, there is used a step which further includes a step of selectively removing the region in which ions have been implanted, following the above-described step of implanting ions. For example, the base material part 30 in FIG. 1E, i.e., a part of Si containing Ga ions, is selectively removed using a solution. Any solutions, including a hydrochloric acid, which dissolve Ga but not Si can be used. First, the photonic crystal structure illustrated in FIG. 1E is placed in the solution and a wait is made until the base material part 30 completely dissolves. Then, the post-etching structure thus obtained is fully rinsed in water. Finally, the structure is dried to complete the photonic crystal illustrated in FIG. 3. This photonic crystal is formed only of Si and does not contain Ga.

### Exemplary Embodiment 4

In this exemplary embodiment, a description will be made of a constitutional example of a photonic crystal structure to be newly fabricated using the photonic crystal 200 or 300 formed in exemplary embodiment 2 or 3 as a model form. In the present exemplary embodiment, there is used a step which further includes a step of reformulating, by heat treatment, the region in which ions have been implanted in the base material, following the step of implanting ions. For example, the ambient atmosphere part 50 between the rods 60 of the photonic crystal 200 or 300 is first filled with another material using one of a chemical vapor deposition (CVD) method and an atomic layer deposition (ALD) method. The material is, for example, TiO₂. By optimizing filling conditions, it is possible to densely fill the ambient atmosphere part 50 with no space therein. Then, the outermost rods, among the rods 60, are partially exposed by polishing or dry etching. Then, the rods 60 are completely removed by dry etching or solution etching. Examples of dry etching methods include a method using the XeF₂ gas discussed in exemplary embodiment 2. Any solutions which do not etch TiO₂ can be used for solution etching. For example, a tetramethylammonium hydroxide (TMAH) solution can be used. As the result of the above-described process, there is formed a three-dimensional photonic crystal formed of TiO₂. As an alternative to TiO₂, one of such materials as GaN, SiO₂ and ZnO is available. These materials are evidently applicable, though slightly different from each other in a filling step and the like. Although the material of the substrate 10 is specified as quartz in the foregoing description, no problems will arise even if the material is changed as necessary.

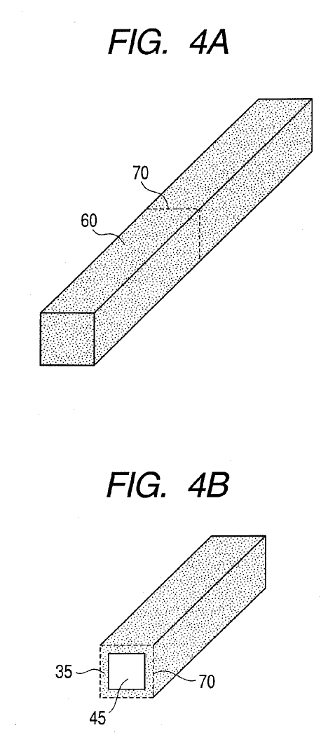

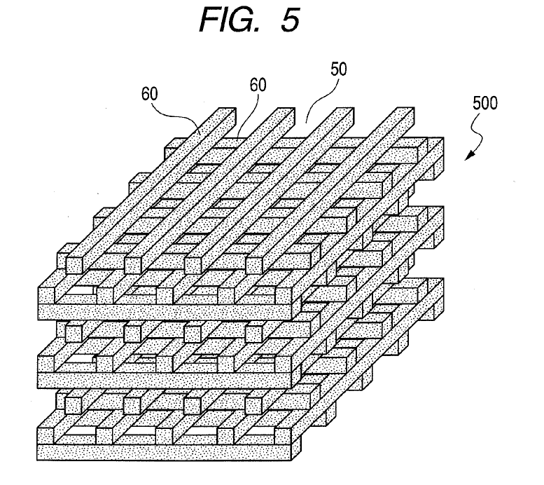

When using the photonic crystal 200 as a model form, the rods thereof may be the same as the rod illustrated in FIGS. 4A and 4B. That is, when a view is taken of the cross section 70 of the rod, it is understood that no Ga ions are arranged in the internal part 45 of the rod, whereas Ga ions are arranged on the surface 35 of the rod. Accordingly, it is possible to shorten the time required to implant Ga ions. Using the above-described technique, it is also possible to form a photonic crystal formed of a material completely different in material from the photonic crystal initially formed in the film-forming step and the ion arrangement step. Note that plasma etching, gas etching or solution etching can be used, for example, in a step of selectively removing the region in which ions have been implanted in exemplary embodiments 2 to 4 described above or the part not containing ions other than the ion-implanted region.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-144443, filed May 31, 2007, which is hereby incorporated by reference herein in its entirety.

What is claimed is:

1. A photonic crystal structure the optical characteristics of which vary periodically in at least one direction, wherein the base material of the photonic crystal structure is formed of a dielectric material, a region containing at least one of molecules, atoms and ions different from the constituent element of the base material is provided in the base material, and the region is arranged in the base material so that the density of one of the molecules, atoms and ions varies periodically in the one direction.

2. The photonic crystal structure according to claim 1, wherein the base material of the photonic crystal structure is one of a continuous body and a multilayer film.

3. The photonic crystal structure according to claim 1, wherein the dielectric material is one of Si and a compound containing Si.

4. The photonic crystal structure according to claim 1, wherein the dielectric material constituting the base material is formed of two types of dielectric materials and the region is formed in a base material made of at least one of the two dielectric materials.

5. The photonic crystal structure according to claim 4, wherein one type of the dielectric materials is one of vacuum and a gas containing air and the other type of the dielectric materials is one of Si and a compound containing Si.

6. The photonic crystal structure according to claim 5, wherein the base material of the photonic crystal structure is a multilayer film.

7. The photonic crystal structure according to claim 1, wherein at least one of the molecules, atoms and ions is a metal selected from the group consisting of Ga and In or a nonmetal selected from the group consisting of B. P, Si, Ar, oxygen and nitrogen.

8. The photonic crystal structure according to claim 1, wherein the period at which the optical characteristics vary periodically is several tens of nanometers to several tens of micrometers.

9. The photonic crystal structure according to claim 1, wherein the period at which the density of one of the molecules, atoms and ions varies periodically is several tens of nanometers to several tens of micrometers.

10. A method of manufacturing a photonic crystal structure the optical characteristics of which vary periodically in at least one direction, the method comprising:
preparing the base material of the photonic crystal structure; and;
implanting ions by scanning a focused ion beam on the base material while varying the acceleration voltage of the focused ion beam, in order to form an ion-implanted region in the base material, so that the density of the ions varies periodically in the one direction as the result of the region being formed.

11. The method of manufacturing a photonic crystal structure according to claim 10, wherein a thin film is formed as the base material in the preparation of the base material of the photonic crystal structure.

12. The method of manufacturing a photonic crystal structure according to claim 11, wherein the thin film is formed using one of sputtering, vacuum deposition, chemical vapor deposition and epitaxial growth.

13. The method of manufacturing a photonic crystal structure according to claim 10, further including selectively removing the region in which ions have been implanted or parts not containing the ions other than the region in which ions have been implanted, following the ion implantation.

14. The method of manufacturing a photonic crystal structure according to claim 13, wherein the selective removal of the region in which ions have been implanted or parts not containing the ions other than the region in which ions have been implanted is performed by one of plasma etching, gas etching and solution etching.

15. The method of manufacturing a photonic crystal structure according to claim 10, further including reformulating, by heat treatment, the region in which ions have been implanted in the base material, following the ion implantation.
